(19) United States
(12) Patent Application Publication
(10) Pub. No.: US 2022/0114639 A1
(43) Pub. Date: Apr. 14, 2022

(54) RECOMMENDING PRODUCTS USING ARTIFICIAL INTELLIGENCE

(71) Applicant: Micron Technology, Inc., Boise, ID (US)

(72) Inventors: Carla L. Christensen, Boise, ID (US); Bhumika Chhabra, Boise, ID (US); Radhika Viswanathan, Boise, ID (US); Zahra Hosseinimakarem, Boise, ID (US)

(21) Appl. No.: 17/066,827

(22) Filed: Oct. 9, 2020

(51) Int. Cl. G06Q 30/06; G06T 19/00; G06T 1/20

(52) U.S. Cl. CPC G06Q 30/0631; G06T 19/006; G06Q 30/0643; G06T 1/20; G06Q 30/0627

(57) ABSTRACT

An example method can include receiving at least one of: a product dimension, a product review, a product material, a product color, a product fit, a product style, product manufacturing data, product manufacturer, a product image, or a product three-dimensional (3-D) image at an AI accelerator, receiving at least one of: a user input or user data at the AI accelerator, generating one or more recommended products responsive to the AI accelerator performing an AI operation on at least one of: the product dimension, the product review, the product material, the product color, the product fit, the product style, the product manufacturing data, the product manufacturer, the product image, or the product 3-D image and at least one of: the user input or the user data using the AI model, and display the one or more recommended products on a user interface.

### TECHNICAL FIELD

The present disclosure relates generally to a computing device, and more particularly, to methods, apparatuses, and systems related to recommending products using artificial intelligence (AI).

### BACKGROUND

A computing device can be, for example, a personal laptop computer, a desktop computer, a smart phone, a tablet, a wrist-worn device, a digital camera, and/or redundant combinations thereof, among other types of computing devices.

Computing devices can perform AI operations. In some examples, a computing device can include an AI accelerator. An AI accelerator can include components configured to perform AI operations. In some examples, AI operations may include machine learning or neural network operations, which may include training operations or inference operations, or both.

### BRIEF DESCRIPTION OF THE DRAWINGS

FIG. 1 illustrates an example of a user interface of a computing device for displaying AI-recommended products in accordance with a number of embodiments of the present disclosure.

FIG. 2 illustrates an example of a user interface of a computing device for displaying AI-recommended products in accordance with a number of embodiments of the present disclosure.

FIG. 3 illustrates an example of a computing device used for recommending products using AI and/or displaying the AI-recommended products in accordance with a number of embodiments of the present disclosure.

FIG. 4 illustrates an example of a computing device used for recommending products using AI and/or displaying the AI-recommended products in accordance with a number of embodiments of the present disclosure.

FIG. 5 is a flow diagram of a method for recommending products using AI and displaying the AI-recommended products in accordance with a number of embodiments of the present disclosure.

### DETAILED DESCRIPTION

The present disclosure includes methods, apparatuses, and systems related to recommending products using AI. An example method includes receiving at least one of: a product dimension, a product review, a product material, a product color, a product fit, a product style, product manufacturing data, product manufacturer, a product image, or a product three-dimensional (3-D) image at an AI accelerator, receiving at least one of: a user input or user data at the AI accelerator, generating one or more recommended products responsive to the AI accelerator performing an AI operation on at least one of: the product dimension, the product review, the product material, the product color, the product fit, the product style, the product manufacturing data, the product manufacturer, the product image, or the product 3-D image and at least one of: the user input or the user data using the AI model, and display the one or more recommended products on a user interface.

The AI model can be trained and/or partially trained on the computing device and/or on a cloud device. For example, the AI model can be partially trained at a cloud device using product data available on the Internet. The cloud device can send the AI model to the computing device. The computing device can continue training the AI model using user input and/or user data. For example, weights in the AI model can be developed based on the user input and/or user data at the computing device.

The AI operations can recommend one or more products for a user based on the user input, the user data, and/or the product data provided by the product website, for example. The user input can be a key word, a phrase, a sentence, data, a picture, and/or a video entered by the user. The user data can include a user's pictures, past purchasing transactions, product reviews, Internet browsing history, and/or social media activity.

The product data including product dimensions, product reviews, product material, product color, product fit, product style, product manufacturing data, product manufacturer (e.g., brand), product images, and/or product 3-D images can be sent from a different computing device. For example, the different computing device can be the server hosting a product website and/or a third-party website.

Once one or more products are recommended as a product the user may be interested in, the one or more products can be displayed on a user interface of the computing device. The user interface can display one or more images of the one or more products and/or other product data. For example, other product data can include product dimensions, product reviews, manufacturing data, material data, fit data, color data, and/or style data.

In a number of embodiments, one or more products can be displayed using virtual reality (VR), augmented reality (AR), and/or mixed reality (MR). VR can immerse a user in an artificial digital environment, AR can overlay virtual objects on a real-world environment, and MR can overlay and anchor virtual objects to a real-world environment. In some examples, a three-dimensional (3-D) image of one or more products can be displayed via a user interface on a user and/or a user's 3-D image using VR, AR, and/or MR. The user interface can be, for example, a holographic display, a near eye display, a light field display, and/or a headset.

As used herein, “a number of” something can refer to one or more of such things. For example, a number of computing devices can refer to one or more computing devices. A “plurality” of something intends two or more. Additionally, designators such as “Y”, as used herein, particularly with respect to reference numerals in the drawings, indicates that a number of the particular feature so designated can be included with a number of embodiments of the present disclosure.

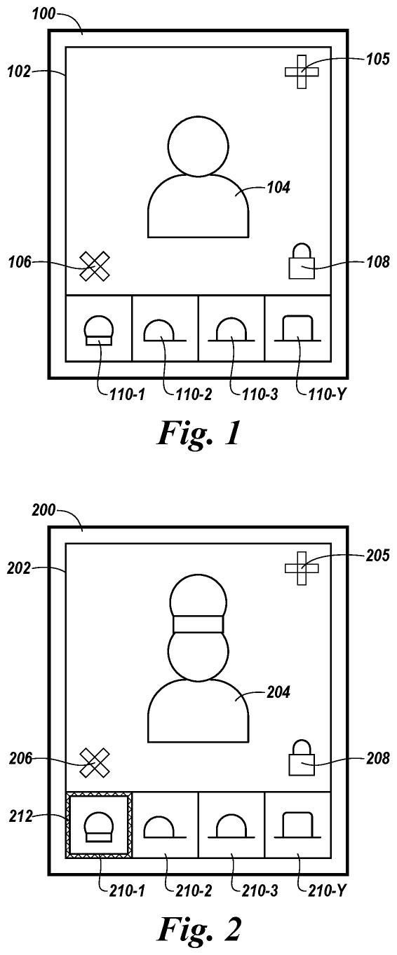

The figures herein follow a numbering convention in which the first digit or digits correspond to the drawing figure number and the remaining digits identify an element or component in the drawing. Similar elements or components between different figures may be identified by the use of similar digits. For example, reference numeral 102 may reference element “2” in FIG. 1, and a similar element may be referenced as 202 in FIG. 2. In some instances, a plurality of similar, but functionally and/or structurally distinguishable, elements or components in the same figure or in different figures may be referenced sequentially with the same element number (e.g., 110-1, 110-2, 110-3, and 110-Y in FIG. 1). As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

FIG. 1 illustrates an example of a user interface 102 of a computing device 100 for displaying AI-recommended products in accordance with a number of embodiments of the present disclosure. The user interface 102, as illustrated in FIG. 1, can further include a 3-D image 104, a user input icon 105, a remove icon 106, a purchase icon 108, and one or more products 110-1, 110-2, 110-3, . . . , 110-Y.

As used herein, a 3-D image can be a model and/or a figure representing a particular person, animal, and/or object in VR, AR, and/or MR. A 3-D image can be rendered by combining one or more images. The one or more images can be created by scanning, photographing, and/or video recording a person, animal, and/or object. For example, a person can be scanned using an infrared scanner (IR) and an illuminator detector, measured using a Time-of-flight sensor, and/or photographed using a camera. In some examples, the one or more images can be retrieved from memory on and/or external to the computing device 100, retrieved from social media, and/or retrieved from the Internet.

Although FIG. 1 illustrates one 3-D image, the user interface 102 can include a number of 3-D images. In some examples, the user interface 102 can be a holographic display, a near eye display, a light field display, or a virtual reality headset. The user interface 102 can be included in glasses, a windshield, a vehicle, and/or an appliance, for example. The number of 3-D images can be the same person, a number of different people, a number of animals, and/or a number of objects. The number of objects can create a room and/or an environment, for example.

The one or more products 110-1, 110-2, 110-3, . . . , 110-Y can be similarly rendered by scanning, photographing, recording, and/or retrieving one or more images of the one or more products 110-1, 110-2, 110-3, . . . , 110-Y and combining the one or more images to create a 3-D image. The one or more products 110-1, 110-2, 110-3, . . . , 110-Y can be listed and/or displayed as an image, as illustrated in FIG. 1. For ease of illustration, the one or more products 110-1, 110-2, 110-3, . . . , 110-Y are shown in FIG. 1 as a number of hats, embodiments are not so limited. The one or more products 110-1, 110-2, 110-3, . . . , 110-Y can be different types, different sizes, different colors, different patterns, and/or different materials, for example.

The user interface 102 can be generated by the computing device 100. The user interface 102 can be a graphical user interface (GUI) that can provide and/or receive information to and/or from the user of the computing device 100. The user interface 102 can be shown on a display of the computing device 100. In some examples, the display can be a touchscreen.

In a number of embodiments, the user interface 102 can be generated in response to an input from a user (e.g., a person). A user can generate the user interface 102 by visiting a website, visiting a particular website page, and/or opening and/or using an application installed on the computing device 100.

The user can enter user input via the user interface 102. In some examples, the user can select a user input icon 105 and input a key word, a phrase, a sentence, and/or attach data, a picture, and/or a video. A user input can include, but is not limited to, weather data, an event, a location, a date, a picture of a person with a style they like, a picture of what their date and/or friend is wearing, a picture of their favorite hat, a brand name, a type of clothing, a clothing material, a measurement size, and/or a color they like. In some examples, the user can provide user input using filters. For example, the user can select a fabric, color, and/or a type of clothing from a menu. The computing device 100 can recommend products based on the user input provided by the user.

In some examples, the computing device 100 can generate one or more questions for the user and display the one or more questions on the user interface 102. The user can input responses to the one or more questions via the user interface 102. In response to receiving the responses, the computing device 100 can recommend one or more products.

Once the computing device 100 recommends one or more products, the user can view the one or more products 110-1, 110-2, 110-3, . . . , 110-Y in response to a user's selections (e.g., pressing, tapping, and/or clicking) on the user interface 102. For example, a user can view a product of the one or more products 110-1, 110-2, 110-3, . . . , 110-Y by selecting the product.

A user can remove a product of the one or more products 110-1, 110-2, 110-3, . . . , 110-Y from the 3-D image 104 and/or from the user interface 102 by selecting the product image of the one or more products 110-1, 110-2, 110-3, . . . , 110-Y followed by selecting the remove icon 106. The computing device 100 can remove the one or more products 110-1, 110-2, 110-3, . . . , 110-Y responsive to receiving the selection of the remove icon 106. Similarly, a user can purchase a product of the one or more products 110-1, 110-2, 110-3, . . . , 110-Y by selecting the product of the one or more products 110-1, 110-2, 110-3, . . . , 110-Y followed by selecting the purchase icon 108. The computing device 100 can execute a purchase transaction of the one or more products 110-1, 110-2, 110-3, . . . , 110-Y responsive to receiving the selection of the purchase icon 108. Although not shown, the user interface 102 can include a number of other icons to perform a number of different operations.

In a number of embodiments, the 3-D image 104 can be moved, rotated, and/or orientated differently. The 3-D image 104 can be moved responsive to a user selecting the 3-D image 104 and dragging (e.g., swiping) the 3-D image 104 in a direction, a user selecting a move icon (e.g., a rotate icon, pan icon, etc.), and/or the 3-D image 104 can move responsive to a user moving, for example.

AI operations can be used to recommend the one or more products 110-1, 110-2, 110-3, . . . , 110-Y. User data stored in memory, on social media, and/or on the Internet can include a number of flagged products. Flagged products can be products viewed, liked, used and/or worn by the user. These flagged products can be used to recommend products to the user by comparing characteristics (e.g., type, shape, style, size, color, brand, cost, etc.) of the flagged products with characteristics of other products. In some examples, products can be recommended based on a user's purchasing history, a user's calendar, a user's reviews, and/or third-party reviews.

In a number of embodiments, the computing device 100 can be a mobile device. A user can look at a clothing website using the mobile device. A server hosting the website can receive user data from the mobile device. For example, the mobile device can send recent internet browsing history of the user to the server. The server using AI operations can determine one or more products that the user would be interested in purchasing. For example, the AI operations can determine that the user would like to purchase a baseball cap based on the recent internet browsing history of the user.

Once the server determines what the user would like, the server can use AI operations to determine the one or more products that match or are similar to what the user would like. For example, the AI operations can determine the one or more products on the website that are baseball caps. The one or more baseball caps can be displayed to the user on the mobile device. In some examples, the one or more baseball caps can be displayed on a 3-D image of the user.

FIG. 2 illustrates an example of a user interface 202 of a computing device 200 for displaying AI-recommended products in accordance with a number of embodiments of the present disclosure. The user interface 202, as illustrated in FIG. 2, can further include a 3-D image 204, a user input icon 205, a remove icon 206, a purchase icon 208, and one or more products 210-1, 210-2, 210-3, . . . , 210-Y.

In some examples, the user interface 202 can include an outline 212. The outline 212 can indicate a selection of a product of the one or more products 210-1, 210-2, 210-3, . . . , 210-Y. Embodiments of the present disclosure, however, are not limited to an outline to indicate a selection. Other indications of a selection can be used, for example, a product can be colored differently and/or highlighted responsive to a selection. As shown in FIG. 2, the user interface 202 includes outline 212 around product 210-1. The user interface 202 includes outline 212 responsive to the user interface 202 receiving a selection of the product 210-1.

One or more products 210-1, 210-2, 210-3, . . . , 210-Y can be magnified or placed on and/or worn by the 3-D image 204 responsive to a user selecting the one or more products 210-1, 210-2, 210-3, . . . , 210-Y. For example, product 210-1 can be placed on 3-D image 204, as illustrated in FIG. 2, responsive to a user selecting product 210-1.

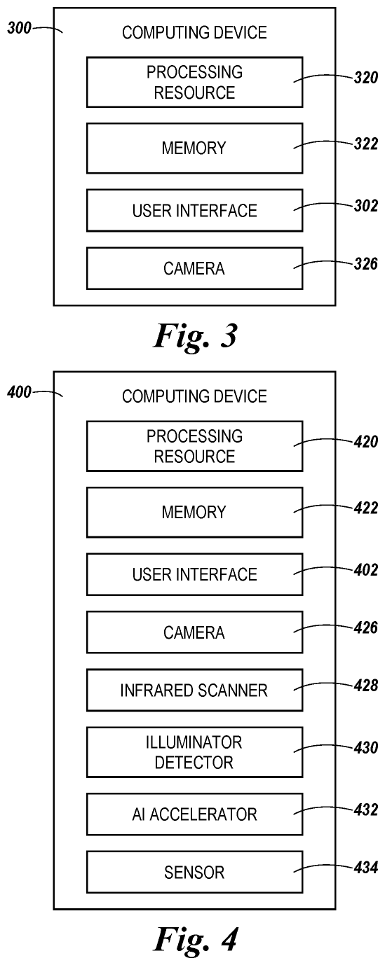

FIG. 3 illustrates an example of a computing device 300 used for recommending products using AI and/or displaying the AI-recommended products in accordance with a number of embodiments of the present disclosure. The computing device 300 can be an apparatus. As illustrated in FIG. 3, computing device 300 can include a processing resource (e.g., processor) 320, a memory 322, a user interface 302, and a camera 326. The computing device 300 can be, for example, a personal laptop computer, a desktop computer, a smart phone, a tablet, a wrist-worn device, a digital camera, and/or redundant combinations thereof, among other types of computing devices.

The memory 322 can be any type of storage medium that can be accessed by the processing resource 320 to perform various examples of the present disclosure. For example, the memory 322 can be a non-transitory computer readable medium having computer readable instructions (e.g., computer program instructions) stored thereon that are executable by the processing resource 320 to receive signaling including data representing a product dimension, a product review, a product material, a product color, a product fit, a product style, product manufacturing data, product manufacturer, a product image, or a product 3-D image at an AI accelerator (e.g., AI accelerator 432 in FIG. 4) of the computing device 300 from a radio in communication with a processing resource of a server, receive signaling including data representing a user input and/or user data at the AI accelerator from a radio in communication with the processing resource 320 of the computing device 300, generate additional data representing one or more products recommended responsive to the AI accelerator of the computing device 300 performing an AI operation on the data representing at least one of: the product dimension, the product review, the product material, the product color, the product fit, the product style, the product manufacturing data, the product manufacturer, the product image, or the product 3-D image and the data representing at least one of: the user input or the user data using an AI model, receive signaling including the additional data representing the one or more products recommended at a user interface 302 of the computing device 300 from a radio in communication with the AI accelerator of the computing device 300, and display the additional data representing the one or more products recommended on the user interface 302 of the computing device 300. As used herein, signaling can include a communication (e.g., a radio signal) that carries data from one location to another. As described above, the computing device 300 can include communication devices, such as, but not limited to, radios.

The memory 322 can be volatile or nonvolatile memory. The memory 322 can also be removable (e.g., portable) memory, or non-removable (e.g., internal) memory. For example, the memory 322 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 322 is illustrated as being located within computing device 300, embodiments of the present disclosure are not so limited. For example, memory 322 can be located on an external computing resource (e.g., enabling computer readable instructions to be downloaded over the Internet or another wired or wireless connection).

As illustrated in FIG. 3, computing device 300 includes a user interface 302. A user (e.g., operator) of computing device 300, can interact with computing device 300 via a user interface 302 shown on a display. For example, the user interface 302 via a display can provide (e.g., display and/or present) information to the user of computing device 300, and/or receive information from (e.g., input by) the user of computing device 300. For instance, in some embodiments, the user interface 302 can be a GUI that can provide and/or receive information to and/or from the user of computing device 300. The display showing the user interface 302 can be, for instance, a touchscreen (e.g., the GUI can include touch-screen capabilities).

The computing device 300 can include one or more cameras 326. The one or more cameras 326 can be used to photograph images and/or record videos of a person and/or product. These images and/or videos can be used to create a 3-D image of a person and/or a product. In a number of embodiments, a 3-D image can be created and/or modified using user data including retrieved images and/or video. The images and/or video can be retrieved from memory 322 on and/or external to the computing device 300, retrieved from social media, and/or retrieved from the Internet.

FIG. 4 illustrates an example of a computing device 400 used for recommending products using AI and/or displaying the AI-recommended products in accordance with a number of embodiments of the present disclosure. Computing device 400 can correspond to computing device 300 in FIG. 3. Computing device 400 can include a processing resource 420, a memory 422, a user interface 402, and a camera 426. The processing resource 420, the memory 422, and the camera 426 can correspond to the processing resource 320, the memory 322, and the camera 326, respectively in FIG. 3. As illustrated in FIG. 4, computing device 400 can further include an infrared scanner 428, an illuminator detector 430, an AI accelerator 432, and a sensor 434.

The infrared scanner 428 and the illuminator detector 430 can be used to create and/or modify a 3-D image. In a number of embodiments, the computing device 400 can receive data from an external scanner to create and/or modify a 3-D image.

The AI accelerator 432 can include hardware and/or software/firmware, not shown, to perform AI operations using an AI model. The AI model can be trained and/or partially trained on the computing device 400 and/or on a cloud device. For example, the AI model can be partially trained at a cloud device using product data available on the Internet. The cloud device can send the AI model to the computing device 400 and the computing device 400 can continue training the AI model using user input and user data. For example, weights in the AI model can be developed based on the user input and user data at the computing device 400.

Data stored in memory 422 on the computing device 400 and/or external to the computing device 400 can be used in performing the AI operations. The data can include user input, user data, and/or product data. User input data can be a key word, phrase, sentence, data, picture, and/or video inputted by the user. User data can include data stored in memory 422, retrieved from social media, and/or retrieved from the Internet. For example, the user data can include a user's pictures, past purchasing transactions, product reviews, Internet browsing history, and/or social media activity. In some examples, a user can select what user data is used when performing AI operations. A computing device 400 can add particular data to the user data to be inputted into the AI model responsive to receiving a selection of the particular data from the user.

In a number of embodiments, product data can be received from a different computing device and/or stored in memory 422 on the computing device 400, retrieved from social media, and/or retrieved from the Internet. In some examples, the different computing device can be a server hosting a product website and/or a third-party website. The product data can include product dimensions, product reviews, manufacturing data, material data, fit data, color data, style data, product images, and/or 3-D images.

In some examples, the AI accelerator 432 can perform AI operations including machine learning or neural network operations, which may include training operations or inference operations, or both. The AI operations can recommend one or more products for a user based on the user data and the product data provided by the product website, for example.

User data can include a number of flagged products. Flagged products can be, but are not limited to, products viewed, liked, used and/or worn by the user. These flagged products can be used to identify products to recommend to the user by comparing characteristics (e.g., type, shape, style, size, color, brand, cost, etc.) of the flagged products with characteristics of other products. In some examples, products can be recommended based on a user's purchasing history, a user's calendar, a user's reviews, and/or third-party reviews.

Once one or more products are recommended as a product the user may be interested in, the one or more products can be displayed on the user interface 402 of the computing device 400. The user interface 402 shown on a display can include one or more product images of the one or more products and/or other product data, for example, product dimensions, product reviews, manufacturing data, material data, fit data, color data, and/or style data. In some examples, one or more products can be displayed using VR, AR, and/or MR on the user interface 402.

In a number of embodiments, a 3-D image can be created and/or modified responsive to performing an AI operation. An AI operation can identify changes to a user based on the user data. For example, a user's body and/or image can change over time and the computing device 400 using the AI accelerator 432 can identify these changes using user data. The computing device 400 can change the user's 3-D image to reflect these changes.

Sensor 434 can capture data to input into the AI accelerator 432 to create and/or modify the user's 3-D image. For example, sensor 434 can be a 3-D Time of flight sensor and can capture body measurements of the user by emitting and capturing an infrared (IR) light signal which hits the user's body and returns to the sensor 434. The time it takes for the signal to return to the sensor 434 is measured and provides depth-mapping capabilities.

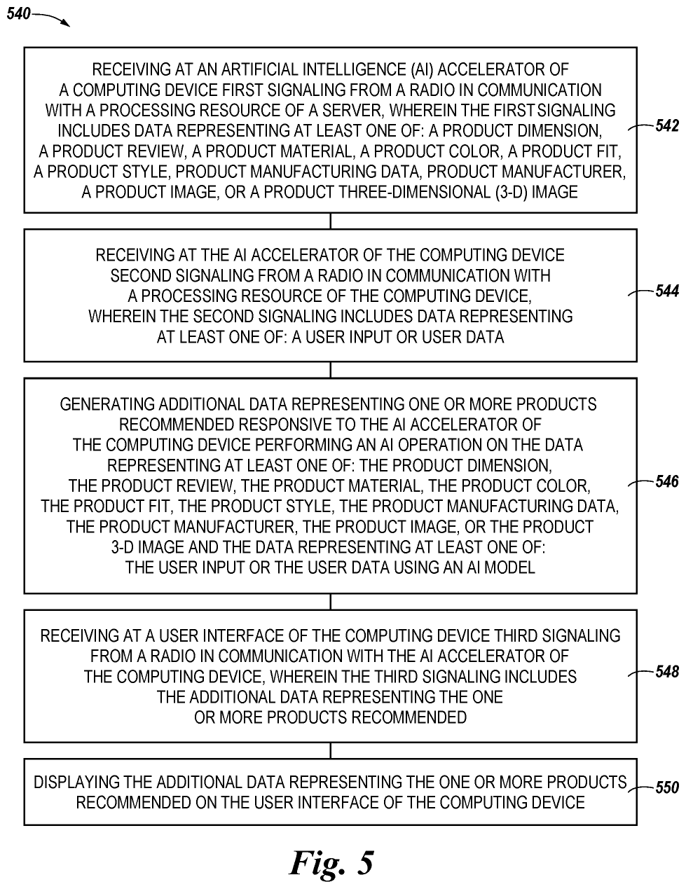

FIG. 5 is a flow diagram of a method 540 for recommending products using AI and displaying the AI-recommended products in accordance with a number of embodiments of the present disclosure. At block 542, the method 540 can include receiving at an AI accelerator of a computing device first signaling from a radio in communication with a processing resource of a server, wherein the first signaling includes data representing at least one of: a product dimension, a product review, a product material, a product color, a product fit, a product style, product manufacturing data, product manufacturer, a product image, or a product 3-D image. In some examples, the server can be associated with a product website and/or a third-party website.

At block 544, the method 540 can include receiving at the AI accelerator of the computing device second signaling from a radio in communication with a processing resource of the computing device, wherein the second signaling includes data representing at least one of: a user input or user data. The user data can be selected by the user in some examples. The user can enter and/or select user data and/or user input via the user interface. User input can include key words, phrases, sentences, data, pictures, and/or video.

In some examples, a signaling including data representing the user data can be received from a radio in communication with a memory of the computing device, the internet, and/or a different computing device. User data can include a number of flagged products. Flagged products can be products viewed, liked, used and/or worn by the user. In a number of embodiments, signaling including data representing weather data, event data, a picture, and/or a fashion icon can be received at the AI accelerator from the radio in communication with the processing resource of the computing device.

At block 546, the method 540 can include generating additional data representing one or more products recommended responsive to the AI accelerator of the computing device performing an AI operation on the data representing at least one of: the product dimension, the product review, the product material, the product color, the product fit, the product style, the product manufacturing data, the product manufacturer, the product image, or the product 3-D image and the data representing at least one of: the user input or the user data using an AI model. In some examples, the AI operation can include machine learning or neural network operations, which may include training operations or inference operations, or both.

The user data including flagged products can be used to identify products to recommend to the user by comparing characteristics (e.g., type, fit, shape, style, size, color, brand, cost, etc.) of the flagged products with characteristics of other products. In some examples, products can be recommended based on a user's purchasing history, a user's calendar, a user's reviews, and/or third-party reviews.

Other products can be recommended to the user responsive to the product having a threshold number of characteristics in common with a flagged product or a threshold number of characteristics different from a flagged product. For example, a product can be recommended responsive to a number of flagged products being a particular type, fit, shape, style, size, color, brand, and/or cost.

In contrast, a product may not be recommended responsive to a user's purchasing history, a user's reviews, and/or third-party reviews. For example, a product may not be recommended if a user has purchased a product with a threshold number of characteristics in common with the product (e.g., a similar product). A similar product can be, for example, a product of the same type, fit, shape, style, and/or color.

At block 548, the method 540 can include receiving at a user interface of the computing device third signaling from a radio in communication with the AI accelerator of the computing device, wherein the third signaling includes the additional data representing the one or more products recommended.

At block 550, the method 540 can include displaying the additional data representing the one or more products recommended on the user interface of the computing device.

The one or more products can be displayed using one or more product images and/or other product data, for example, product dimensions, product reviews, manufacturing data, material data, fit data, color data, and/or style data. In a number of embodiments, one or more products can be displayed using VR, AR, and/or MR. For example, one or more products can be displayed on a 3-D model of a user.

The user interface can be generated by the computing device. The user interface can be a GUI that can provide and/or receive information to and/or from the user of the computing device. The user interface can be shown on a display. Once the user interface is generated on the computing device, the user can view the one or more products in response to a user's selections on the user interface. For example, a user can view a product of the one or more products by selecting the product.

A user can remove a product of the one or more products from the 3-D image and/or from the user interface by selecting the product image followed by selecting the remove icon. The computing device can remove the product responsive to receiving the selection of the remove icon. Similarly, a user can purchase a product by selecting the product followed by selecting the purchase icon. The computing device can execute a purchase transaction of the product responsive to receiving the selection of the purchase icon.

In a number of embodiments, the 3-D image can be moved, rotated, and/or orientated differently in response to receiving a signal including data representing a command from a radio in communication with the processing resource of the computing device. The 3-D image can be moved responsive to a user selecting the 3-D image and dragging the 3-D image in a direction, responsive to a user selecting a move icon, and/or responsive to a user moving, for example. The computing device can move the 3-D image responsive to receiving a selection of the 3-D image, a selection of the move icon, and/or receiving an indication of movement from the user.

Signaling including data representing a 3-D image of the one or more products recommended can be received via the user interface from the radio in communication with the AI accelerator. The 3-D image of the one or more products recommended can be displayed on AR, MR, and/or VR via a holographic display, a near eye display, a light field display, and/or a virtual reality headset.

In some examples, the user interface can receive signaling including data representing different user input and/or different user data from a radio in communication with the processing resource of the computing device. In response to receiving the signaling including the data representing the different user input and/or the different user data the 3-D image of the one or more products recommended can be modified.

In a number of embodiments, the user interface can display data representing one or more questions selected responsive to the AI accelerator performing the AI operation. The user interface can receive signaling including data representing the one or more questions from the radio in communication with the AI accelerator and display the data representing the one or more questions prior to generating the additional data representing the one or more products recommended. A user can provide answers to the one or more questions via the user interface and signaling including data representing the answers to the one or more questions can be received at the AI accelerator. In some examples, the one or more products recommended can be at least partially based on the user's answers to the one or more questions.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving at an artificial intelligence (AI) accelerator of a computing device first signaling from a radio in communication with a processing resource of a server, wherein the first signaling includes data representing at least one of: a product dimension, a product review, a product material, a product color, a product fit, a product style, product manufacturing data, product manufacturer, a product image, or a product three-dimensional (3-D) image;
receiving at the AI accelerator of the computing device second signaling from a radio in communication with a processing resource of the computing device, wherein the second signaling includes data representing at least one of: a user input or user data;
generating additional data representing one or more products recommended responsive to the AI accelerator of the computing device performing an AI operation on the data representing at least one of: the product dimension, the product review, the product material, the product color, the product fit, the product style, the product manufacturing data, the product manufacturer, the product image, or the product 3-D image and the data representing at least one of: the user input or the user data using an AI model;
receiving at a user interface of the computing device third signaling from a radio in communication with the AI accelerator of the computing device, wherein the third signaling includes the additional data representing the one or more products recommended; and
displaying the additional data representing the one or more products recommended on the user interface of the computing device.

2. The method of claim 1, further comprising:
selecting one or more questions responsive to the AI accelerator performing the AI operation;
receiving at the user interface fourth signaling from the radio in communication with the AI accelerator, wherein the fourth signaling includes data representing the one or more questions selected; and
displaying the data representing the one or more questions selected on the user interface prior to generating the additional data representing one or more products recommended.

3. The method of claim 1, further comprising:
receiving at the AI accelerator fourth signaling from the radio in communication with the processing resource of the computing device, wherein the fourth signaling includes data representing at least one of: weather data, event data, a picture, or a fashion icon.

4. The method of claim 1, further comprising:
receiving at the user interface fourth signaling from the radio in communication with the AI accelerator, wherein the fourth signaling includes data representing a 3-D image of the one or more products recommended; and
displaying the 3-D image of the one or more products recommended on augmented reality (AR) via at least one of: a holographic display, a near eye display, a light field display, or a virtual reality headset.

5. The method of claim 1, further comprising:
receiving at the user interface fourth signaling from the radio in communication with the AI accelerator, wherein the fourth signaling includes data representing a 3-D image of the one or more products recommended; and
displaying the 3-D image of the one or more products recommended on mixed reality (MR) via at least one of: a holographic display, a near eye display, a light field display, or a virtual reality headset.

6. The method of claim 1, further comprising:
receiving at the user interface fourth signaling from the radio in communication with the AI accelerator, wherein the fourth signaling includes data representing a 3-D image of the one or more products recommended; and
displaying the 3-D image of the one or more products recommended on virtual reality (VR) via at least one of: a holographic display, a near eye display, a light field display, or a virtual reality headset.

7. The method of claim 6, further comprising:
receiving at the user interface fifth signaling from the radio in communication with the processing resource of the computing device, wherein the fifth signaling includes data representing a command; and
moving the 3-D image of the one or more products recommended responsive to receiving the fifth signaling.

8. The method of claim 6, further comprising:
receiving at the user interface fifth signaling from the radio in communication with the processing resource of the computing device, wherein the fifth signaling includes data representing at least one of: different user input or different user data; and
modifying the 3-D image of the one or more products recommended responsive to receiving the fifth signaling.

9. The method of claim 1, further comprising:
receiving at the AI accelerator of the computing device the second signaling from the radio in communication with the processing resource of the computing device, wherein the second signaling includes user data selected by the user.

10. An apparatus, comprising:
a user interface;
a memory;
an artificial intelligence (AI) accelerator; and
a first processor configured to execute executable instructions stored in the memory to:
receive at the AI accelerator first signaling from a radio in communication with a second processor of a server, wherein the first signaling includes data representing at least one of: a product dimension, a product review, a product material, a product color, a product fit, a product style, product manufacturing data, product manufacturer, a product image, or a product three dimensional (3-D) image;
receive at the AI accelerator second signaling from a radio in communication with the first processor, wherein the second signaling includes data representing at least one of: a user input or user data;
generate additional data representing one or more products recommended responsive to the AI accelerator performing an AI operation on the data representing at least one of: the product dimension, the product review, the product material, the product color, the product fit, the product style, the product manufacturing data, the product manufacturer, the product image, or the product 3-D image and the data representing at least one of: the user input or the user data using an AI model;
receive at the user interface third signaling from a radio in communication with the AI accelerator, wherein the third signaling includes data representing a 3-D image of the one or more products recommended; and
display the 3-D image of the one or more products recommended on at least one of: augmented reality (AR), virtual reality (VR), or mixed reality (MR).

11. The apparatus of claim 10, wherein the user data includes at least one of: pictures, past purchasing transactions, or user product reviews.

12. The apparatus of claim 10, the first processor further configured to execute executable instructions stored in the memory to:
receive at the first processor a fourth signaling from a radio in communication with at least one of: the memory or the internet, wherein the fourth signaling includes at least a portion of the data representing the user data.

13. An apparatus, comprising:
a memory;
an artificial intelligence (AI) accelerator; and
a first processor configured to execute executable instructions stored in the memory to:
receive at the AI accelerator first signaling from a radio in communication with the first processor, wherein the first signaling includes data representing at least one of: a product dimension, a product review, a product material, a product color, a product fit, a product style, product manufacturing data, product manufacturer, a product image, or a product three dimensional (3-D) image;
receive at the AI accelerator second signaling from a radio in communication with a second processor of a computing device, wherein the second signaling includes data representing at least one of: a user input or user data;
generate additional data representing one or more recommended products responsive to the AI accelerator performing an AI operation on the data representing at least one of: the product dimension, the product review, the product material, the product color, the product fit, the product style, the product manufacturing data, the product manufacturer, the product image, or the product 3-D image and the data representing at least one of: the user input or the user data using an AI model;
receive at a user interface third signaling from a radio in communication with the AI accelerator, wherein the third signaling includes data representing a 3-D image of the one or more products recommended; and
display the 3-D image of the one or more products recommended on at least one of: augmented reality (AR), virtual reality (VR), or mixed reality (MR).

14. The apparatus of claim 13, wherein the one or more products are recommended at least partially based on color of the one or more products.

15. The apparatus of claim 13, wherein the one or more products are recommended at least partially based on fit of the one or more products.

16. The apparatus of claim 13, wherein the one or more products are recommended at least partially based on style of the one or more products.

17. The apparatus of claim 13, wherein the one or more products are recommended at least partially based on type of the one or more products.

18. The apparatus of claim 13, wherein the one or more products are recommended at least partially based on size of the one or more products.

19. The apparatus of claim 13, wherein the one or more products are recommended at least partially based on reviews of the one or more products.

20. The apparatus of claim 13, the processor further configured to execute executable instructions stored in the memory to:
receive at the first processor a fourth signaling from a radio in communication with the internet, wherein the fourth signaling includes at least a portion of the data representing at least one of: the product dimension, the product review, the product material, the product color, the product fit, the product style, the product manufacturing data, the product manufacturer, the product image, or the product 3-D image.
